(19) United States
(12) Patent Application Publication
(10) Pub. No.: US 2025/0259161 A1
(43) Pub. Date: Aug. 14, 2025

(54) SYSTEMS AND METHODS FOR AUTHENTICATION AND CARD PROVISIONING IN DESKTOP MERCHANT CHECKOUTS

(71) Applicant: Capital One Services, LLC, McLean, VA (US)

(72) Inventors: Jeffrey RULE, Chevy Chase, MD (US); Megan M. LOWE, Henrico, VA (US)

(21) Appl. No.: 18/440,443

(22) Filed: Feb. 13, 2024

(51) Int. Cl. G06Q 20/32; G06Q 20/40

(52) U.S. Cl. CPC G06Q 20/3276; G06Q 20/4012; G06Q 20/40145

(57) ABSTRACT

Systems and methods for user authentication and account provisioning involving scanning a QR code, authenticating a user, selecting a transaction account, and completing a transaction.

### FIELD OF THE DISCLOSURE

The present disclosure relates to user authentication and card provisioning in desktop merchant checkouts.

### BACKGROUND

Traditional desktop checkout experiences lack robust authentication methods, posing security risks and hindering user convenience. For example, traditional desktop checkouts typically don't allow users to provide biometrics such as face identification. The absence of efficient authentication and card provisioning mechanisms on desktop platforms creates challenges in ensuring secure transactions and streamlined checkout processes.

These and other deficiencies exist. Therefore, there is a need to provide systems and methods that overcome these deficiencies.

### SUMMARY OF THE DISCLOSURE

In some aspects, the techniques described herein relate to a method for user authentication and card provisioning, including: scanning, by user device application including instructions for execution on a user device including a processor and a memory, a quick response (QR) code from an electronic display; receiving, by the user device application, an authentication request from a server; transmitting, by the user device application, an authentication credential to the server; receiving, by the user device application from the server, a list of one or more transaction accounts associated with one or more account providers associated with the user; and transmitting, by the user device application to the server, a selection of one transaction account, wherein the selection triggers the server to transmit one transaction account information to a merchant, and wherein the transaction account information is sufficient to complete a transaction.

In some aspects, the techniques described herein relate to a system for user authentication and card provisioning, including: user device application including instructions for execution on a user device including a processor and a memory, the user device application configured to: scan a quick response (QR) code from an electronic display; receive an authentication request from a server; transmit an authentication credential to the server; receive a list of one or more account providers associated with the user; and transmit, by the processor to the server, a selection of one transaction account, wherein the selection triggers the server to transmit transaction account information to a merchant, and wherein the transaction account information is sufficient to complete a transaction.

In some aspects, the techniques described herein relate to a computer readable non-transitory medium including computer executable instructions that, when executed by a computer hardware arrangement including a processor, causes the computer hardware arrangement to perform procedures including: scanning a quick response (QR) code from electronic display; receiving an authentication request from a server; transmitting an authentication credential to the server; receiving, from the server, a list of one or more account providers associated with the user; and transmitting, to the server, a selection of one account provider, wherein the selection triggers the server to transmit one or more transaction account information to a merchant, and wherein the transaction account information is sufficient to complete a transaction.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is a system diagram illustrating a system according to an exemplary embodiment.

FIG. 2 is a sequence diagram illustrating a process according to an exemplary embodiment.

FIGS. 3A-3D are diagrams illustrating a process according to an exemplary embodiment.

FIG. 4 is a flowchart illustrating a method according to an exemplary embodiment.

FIG. 5 is a sequence diagram illustrating a process according to an exemplary embodiment.

FIG. 6 is a flowchart illustrating a process according to an exemplary embodiment.

FIG. 7 is a diagram illustrating a neural network according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment and that the specific features or advantages of an embodiment can be interchangeably combined with the specific features and advantages of any other embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The present disclosure addresses the aforementioned problems by leveraging user devices to enhance authentication and card provisioning in desktop merchant checkouts. By integrating a software development kit (SDK) into merchant websites and generating Quick Response (QR) codes, the present disclosure enables customers to utilize their user devices to scan the QR code and authenticate themselves using methods like FaceID, TouchID, or username/password through a user device application. This approach provides a secure and convenient means of authentication that goes beyond the limitations of traditional desktop checkout systems.

Furthermore, the present disclosure establishes application programming interface (API)-based integration between participating banks or a centralized bank service and the merchant, facilitating the secure transmission of payment information, address details, phone numbers, email addresses, and customer identification to the merchant upon successful authentication. This streamlined communication process ensures that the merchant has access to accurate and up-to-date information for completing the checkout process efficiently.

The inclusion of specific details within the QR code, such as merchant identification, customer identification (ID), email address, and timestamp, enables secure communication between the user device and the merchant website. By enforcing security measures like predefined time limits for transaction completion and using Virtual Card Numbers (VCN) to bind transactions to the originating merchant, the invention enhances the overall security and trustworthiness of the desktop checkout experience.

The present disclosure provides many improvements over conventional merchant technologies. For example, the integration of mobile authentication adds an extra layer of security compared to traditional username and password-based authentication on desktop websites. Furthermore, by leveraging a bank application for authentication, the user can enjoy a seamless and familiar experience, and they do not need to remember separate usernames and passwords for each merchant website. Instead, users can rely on the authentication mechanisms provided by the trusted user device application they are already using, streamlining the login process. Additionally, mobile authentication ensures consistency across different merchant websites. Since the authentication process can be conducted through a trusted bank app, users can have confidence in the security measures implemented by the application and the bank behind it. This reduces the risk of falling victim to phishing attacks or entering login credentials on malicious websites. Furthermore, with mobile authentication, users are less reliant on remembering and entering complex passwords repeatedly. This can alleviate password fatigue and the common security risks associated with weak or reused passwords. Instead, they can rely on the convenience of biometrics or a single strong password.

Some embodiments involve embedding a secure token key (STK) into the merchant websites. When a user accesses the website from a desktop device, the STK detects it and generates a QR code specific to that device. The QR code contains relevant information such as the merchant's name, customer's unique ID, customer's email, and a timestamp. The STK offers several improvements to the authentication process on desktop merchant websites. For example, The STK embedded into the merchant websites generates a QR code that is specific to the desktop device accessing the website. This QR code contains important information such as the merchant's name, customer's unique ID, customer's email, and a timestamp, ensuring that the QR code is unique and secure for checkout. As another example, the QR code generated by the STK includes a timestamp, allowing for the setting of an expiration period for the session. If the user does not return within a certain timeframe, the session can expire, adding an additional layer of security.

The generation and scanning of the QR offer improvements as well. For example, the QR codes provide a seamless transition between different devices, specifically from a desktop website to a mobile phone. When a user accesses a desktop merchant website, the STK generates a device-specific QR code. Scanning this QR code with a mobile phone launches the bank app, allowing the user to continue the authentication process on their user device. This seamless transition improves the user experience and eliminates the need for manual data entry. As another example, QR codes used in this invention contain encrypted information specific to the user, the merchant, and the authentication session. The encoded data is not visible to the naked eye, ensuring that sensitive information remains secure. Additionally, the QR code generation process can incorporate security measures such as one-time use tokens, expiration timestamps, and other authentication mechanisms available. This enhances the overall security of the authentication process.

Additionally, the present disclosure incorporates a novel systems in which a server has a consortium-style relationship with one or more account providers such as bank. A consortium-style approach, in the context of the described scenario, refers to a collaborative framework between the server and one or more account providers, such as banks, to streamline the authentication and payment process. The consortium-style approach allows for the inclusion of multiple banks within the authentication and payment process. This means that users can authenticate and make payments using their accounts from different banks. This approach allows users to leverage their preferred user device application for authentication and payment on the merchant website, enhancing convenience and flexibility. The consortium style approach assumes trust between participating banks. If the user has completed the authentication process with one bank, they are allowed to retrieve cards from multiple banks. This means that once the user has authenticated with one bank, they can access and select cards from different banks assuming trust is established among those banks. This interoperability among banks enhances the user experience by providing a wider range of card options for payment. In cases where multiple bank apps are installed on the user's device, additional decision-making logic can be implemented. For example, the system can choose the first user device application that returns or prioritize a specific user device application based on user preferences. This logic ensures a smooth and efficient selection process for the appropriate user device application.

The present disclosure solves the problem of inadequate authentication methods in desktop checkout experiences by leveraging the capabilities of user devices, integrating with banks through the SDK, and enabling secure communication and efficient provisioning of payment credentials to enhance security, convenience, and user trust during desktop merchant checkouts.

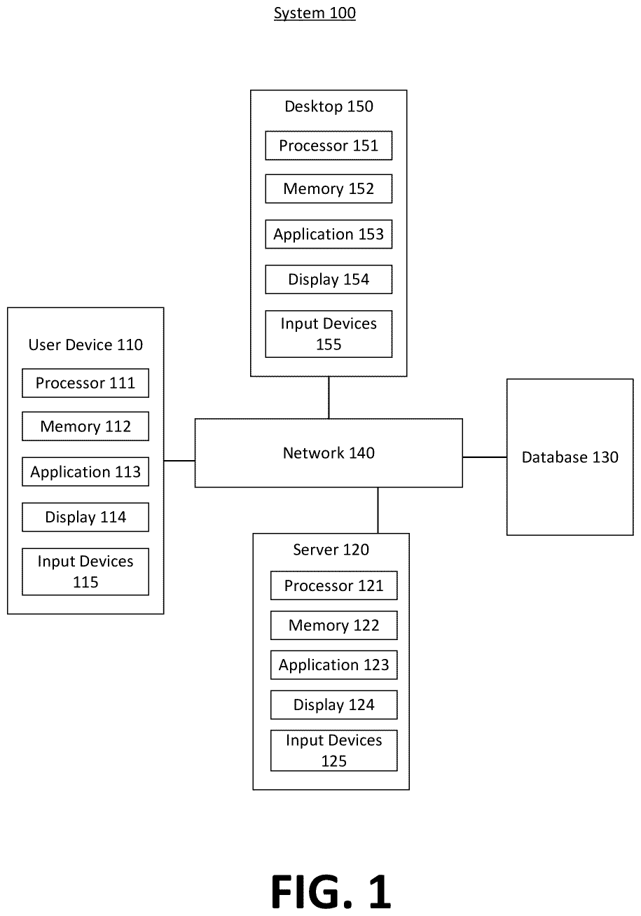

FIG. 1 illustrates a system 100 according to an exemplary embodiment. The system 100 may comprise a user device 110, a server 120, a database 130, a network 140, and a desktop 150. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that, for example, enable network communications with one or more components of the system 100, transmit and/or receive data, and perform the functions described herein. Upon execution by the processor 111, the application 113 may perform the functions described in this specification, specifically to execute and perform the steps and functions in the process flows described herein. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein. The digital camera can include at least: a lens; an image sensor such as without limitation a complementary metal oxide semiconductor (CMOS) or chard charged-coupled device (CCD) sensor; a shutter; an aperture; an image processor, a viewfinder or LCD screen; and storage such as memory cards or secure digital (SD) card.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The server 120 can be onsite, offsite, standalone, networked, online, or offline.

The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory.

Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that, for example, enable network communications with one or more components of the system 100, transmit and/or receive data, and perform the functions described herein. Upon execution by the processor 121, the application 123 may perform the functions described in this specification, specifically to execute and perform the steps and functions in the process flows described herein. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 120.

System 100 may include one or more networks 140. In some examples, the network 140 may be one or more of a wireless network, a wired network or any combination of wireless network and wired network, and may be configured to connect the user device 110, the server 120, and the database 130. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

The desktop 150 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The desktop 150 may include a processor 151, a memory 152, and an application 153. The processor 151 may be a processor, a microprocessor, or other processor, and the desktop 150 may include one or more of these processors.

The processor 151 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 151 may be coupled to the memory 152. The memory 152 may be a read-only memory, write-once read-multiple memory or read/write memory, e.g., RAM, ROM, and EEPROM, and the desktop 150 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 152 may be configured to store one or more software applications, such as the application 153, and other data, such as user's private data and financial account information.

The application 153 may comprise one or more software applications comprising instructions for execution on the desktop 150. In some examples, the desktop 150 may execute one or more applications, such as software applications, that, for example, enable network communications with one or more components of the system 100, transmit and/or receive data, and perform the functions described herein. Upon execution by the processor 151, the application 153 may perform the functions described in this specification, specifically to execute and perform the steps and functions in the process flows described herein. Such processes may be implemented in software, such as software modules, for execution by computers or other machines. The application 153 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The desktop 150 may further include a display 154 and input devices 155. The display 154 may be any type of device for presenting visual information such as a computer monitor, a flat panel display, and a mobile device screen, including liquid crystal displays, light-emitting diode displays, plasma panels, and cathode ray tube displays. The input devices 155 may include any device for entering information into the desktop 150 that is available and supported by the desktop 150, such as a touch-screen, keyboard, mouse, cursor-control device, touch-screen, microphone, digital camera, video recorder or camcorder. These devices may be used to enter information and interact with the software and other devices described herein.

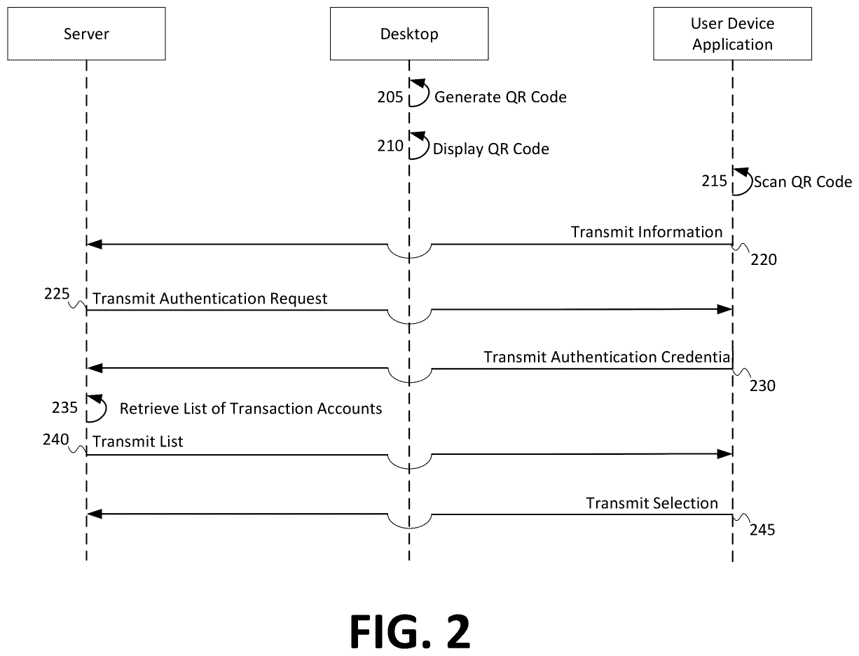

FIG. 2 is a sequence diagram illustrating a process according to an exemplary embodiment. The process can include a server, an electronic display on a computer-enabled device such as a desktop computer, and a user device application user device application comprising instructions for execution on a user device comprising a processor and a memory discussed with further reference to FIG. 1. The desktop and server are also discussed with reference to FIG. 1. The server can be associated with a software application that is responsible for processing information. In FIG. 2, it is assumed that a user is performing a transaction on a desktop, but it is understood that in other embodiments the user may perform the transaction on any computer-enabled device discussed with further reference to FIG. 1. Having selected their item in an online transaction, the user arrives at a checkout page. Instead of inputting their checkout information such as payment and shipping information, the user can instead scan a QR code from the desktop screen to complete the transaction.

In action 205, a QR code can be generated by the desktop. The QR code is generated when a user accesses a merchant's website from a computer device such as a desktop device and initiates the authentication process. Its purpose is to provide a secure and efficient way to transfer essential information between the desktop and mobile devices. The QR code is generated by an STK embedded in the merchant website. When the user accesses the website, the STK detects the device type (e.g. a desktop) and generates a QR code specific to that device. The QR code can contain many kinds of information. In some embodiments, the QR code can contain the merchant's name, the unique identifier for the customer (e.g. customer ID), the user's email address, and a time stamp. For example, the name of the merchant associated with the checkout process is included in the QR code. The customer ID can allow the customer to rejoin the same checkout session when they return to the website on the desktop, ensuring continuity and a seamless user experience. The customer's email address is used by the server as an identifier to determine which banks are associated with that specific email address, thus streamlining the authentication process and allowing for personalized card selection. In such an embodiment, the user could provide their email address before the QR code was generated. Finally, the QR code can include a time stamp to set an expiration period for the session. If the customer does not return within a certain timeframe, the session can expire, ensuring security and preventing unauthorized access. In other embodiments, other kind of customer information can be used such as a name, phone number, account number, address, or other personal identifying information. The generated QR code is then displayed in action 210 on the merchant's website via the display of the desktop, typically in a prominent location where it is easily scannable by a mobile device. Once the QR code is displayed, the user device application can scan the QR code in action 215. In some embodiments, the user device application can be associated with a user device, which can comprise and/or be in data communication with a camera, as discussed with further reference to FIG. 1.

In addition the QR code can contain a universal URL configured to handle scenarios where a user device or mobile device has a specific application installed or does not have the application installed. This can be achieved through deep linking or smart linking. Deep linking allows one to associate a URL with a specific action or content within a mobile application. When a user clicks on a deep link, the operating system checks if the corresponding application is installed on the device. To handle scenarios where the application is not installed, one can set up a fallback URL or webpage. If the application is present, it opens directly to the specified content or performs the associated action. If the application is not installed, the URL can redirect the user to a fallback webpage. This fallback URL can be a regular web URL that users are redirected to if the application is not detected on their mobile device. By combining deep linking and a fallback URL, one can create a URL that intelligently handles both cases. When the user clicks the link, their device checks for the application and opens it if available. If the application is not installed, the device automatically redirects to the fallback webpage.

In action 220, the user device application upon scanning the QR code transmits the information contained in the QR code to the server. In some embodiments, the user can open the user device application, then scan the QR code. The server receives the information from the QR code, i.e. the server decodes the captured QR code image, extracting the encoded information contained within it. This information may include the merchant's name, customer's unique ID, customer's email, and a timestamp. Once the QR code is successfully decoded, the server can transfer the extracted information from the QR code into its own secure environment for further processing. With the relevant information from the QR code, the server initiates the authentication process. In action 225, the server transmit an authentication request to the user device application. In other embodiments, the authentication request can be received outside of the context of the user device application. For example, the user device receives a notification or alert indicating that an authentication request has been received from the application. This notification may appear as a pop-up message, a push notification, or an in-app alert. Based on the provided information, the user decides whether to grant or deny authorization for the requested action. This decision is typically made through user interaction with the user interface either with or without the context of the user device application. In action 230, the user device application can provide an authentication credential that is sufficient to satisfy the authentication request. The user can provide any one of several different credentials: a biometric such as a fingerprint scan, facial recognition (e.g. face ID), iris scanning, and voice scanning; a personal identification number (PIN) or passcode; a one time password (OTP); or a security token.

Having received the authentication credential, the server in action 235 can retrieve a list of one or more transaction accounts associated with the information provided from the QR code, e.g. an email address, phone number, name, account number, customer ID, or some other identifying information. The list can be retrieved by matching the identifying information with one or more transaction accounts from one or more account providers. For example, the server can retrieve a list of three spending accounts from three different banks. These transaction accounts can include various payment methods, such as credit cards, debit cards, digital wallets, or other financial accounts. It is presumed that the server has access to a consortium style approach regarding the access to the one or more transaction accounts. A consortium-style approach, in the context of the described scenario, refers to a collaborative framework between the server and one or more account providers, such as banks, to streamline the authentication and payment process. The consortium-style approach allows for the inclusion of multiple banks within the authentication and payment process. This means that users can authenticate and make payments using their accounts from different banks. In action 240, the server can transmit the list of the transaction accounts to the user device application. The user device application receives the transmitted data and displays the list of transaction accounts to the user. The accounts can be presented in a user-friendly format, showing relevant details such as the account names, associated logos, and potentially other information like available balances or rewards points. In action 245, the user reviews the available transaction accounts and selects the desired account for the transaction, thereby transmitting their selection to the server. They can choose a specific credit card, debit card, or any other supported payment method from the list. Once the user makes their selection, the user device application sends a confirmation or authorization request back to the server. This request includes the chosen transaction account or payment method, indicating the user's intent to use that account for the transaction. The server receives the selection from the user device application and proceeds with processing the transaction using the selected transaction account. This may involve interacting with payment gateways, financial institutions, or other relevant entities to facilitate the transaction.

In some embodiments, the server can transmit a virtual card number (VCN) to the merchant sufficient to complete the transaction. A virtual card number is a temporary and unique card number that is generated for a specific transaction or for a limited duration. It can be associated with a physical or existing credit or debit card associated with one or more transaction accounts from one or more account providers. It exists only in digital form. The VCN can be created electronically by the server. In some embodiments, the VCN can be restricted to further enhance the security of the transaction. For example: VCNs are typically valid for a specific time period. The duration can range from a few hours to several months, depending on the issuer's policies. After the expiration of the VCN, it becomes unusable. As another example, the VCN can be restricted for use with specific merchants or merchant categories. This allows users to limit their VCNs to certain types of transactions or specific online retailers, providing greater control over where the VCN can be used. As another nonlimiting example, VCNs may have transaction-specific limits. This includes limits on the maximum transaction amount or the number of transactions allowed within a specific time frame. These limits help prevent unauthorized or excessive usage. As another nonlimiting example, VCNs can have pre-set spending limits, which restrict the total amount that can be charged using the virtual card number. This ensures that even if the VCN is compromised, the potential financial loss is limited. As another nonlimiting example, the VCN can be single-use only, meaning they can be used for a single transaction and become invalid afterward. Other VCNs may be limited to a certain number of uses before they expire or become inactive. As another nonlimiting example, the VCN can have geographical restrictions, limiting their usage to specific regions or countries.

In still other embodiments, the server can transmit a payment token to the merchant to complete the transaction. In the context of completing online consumer transactions, a payment token is a secure and unique representation of a consumer's payment card information. It is used to facilitate transactions without exposing the actual card details during the payment process. When the consumer selected their preferred transaction account, the information is securely transmitted to the server. The server applies a tokenization process to the card information. This token can be a randomly generated alphanumeric string or a cryptographic representation of the original card details. The payment token is associated with the customer's account or the specific transaction details within the merchant's system. The payment token, along with any necessary information to process transactions, can be securely stored by the server. For example, the token is often stored in a secure database. By generating a payment token and securely storing it instead of storing the actual card details, the server can facilitate transactions without the need to handle or transmit sensitive card information directly, thereby enhancing security and reducing risk. The specific implementation and technical details of tokenization may differ between payment systems, service providers, and industry standards. The exact process may involve additional encryption, decryption, or other security measures based on the specific requirements and protocols being used.

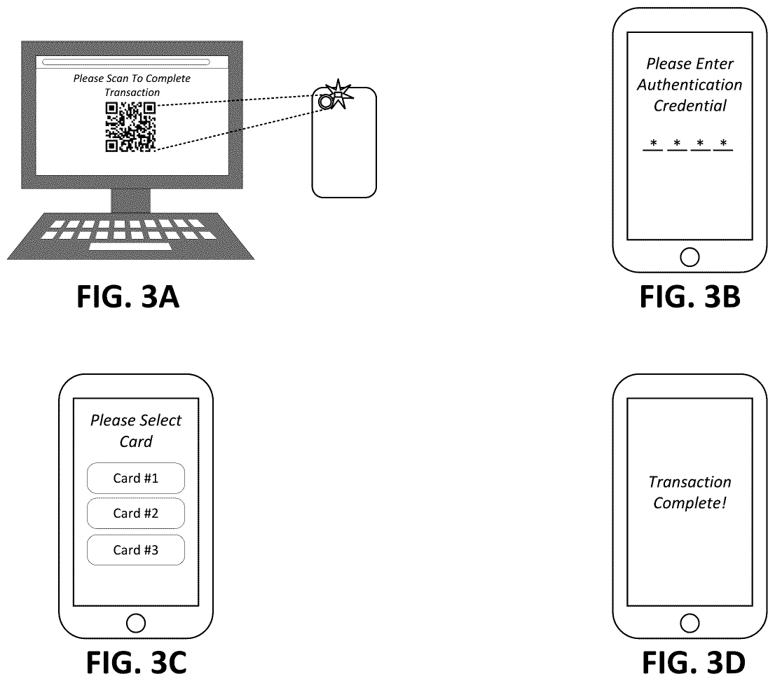

FIG. 3A-3D are diagrams illustrating a process according to an exemplary embodiment. Each of the actions illustrated in FIGS. 3A-3D can be performed by a user device application associated with the user device. In FIG. 3A, a desktop displays a QR code on the screen, and the user scans the QR code with their user device, which is enabled with a camera. The QR code generation process involves the server embedding an STK into the merchant's website. When a user accesses the website from a desktop device, the STK detects it and generates a QR code specific to that device. The QR code contains information such as the merchant's name, customer's unique ID, customer's email, and a timestamp. This information is encoded into the QR code using encoding algorithms. The QR code can contain many kinds of information. In some embodiments, the QR code can contain the merchant's name, the unique identifier for the customer (e.g. customer ID), the user's email address, and a time stamp. For example, the name of the merchant associated with the checkout process is included in the QR code. The customer ID can allow the customer to rejoin the same checkout session when they return to the website on the desktop, ensuring continuity and a seamless user experience. The customer's email address is used by the server as an identifier to determine which banks are associated with that specific email address, thus streamlining the authentication process and allowing for personalized card selection. In such an embodiment, the user could provide their email address before the QR code was generated. Finally, the QR code can include a time stamp to set an expiration period for the session. If the customer does not return within a certain timeframe, the session can expire, ensuring security and preventing unauthorized access. In other embodiments, other kind of customer information can be used such as a name, phone number, account number, address, or other personal identifying information. In addition the QR code can contain a universal URL configured to handle scenarios where a user device or mobile device has a specific application installed or does not have the application installed. This can be achieved through deep linking or smart linking. Deep linking allows one to associate a URL with a specific action or content within a mobile application. When a user clicks on a deep link, the operating system checks if the corresponding application is installed on the device. To handle scenarios where the application is not installed, one can set up a fallback URL or webpage. If the application is present, it opens directly to the specified content or performs the associated action. If the application is not installed, the URL can redirect the user to a fallback webpage. This fallback URL can be a regular web URL that users are redirected to if the application is not detected on their mobile device. By combining deep linking and a fallback URL, one can create a URL that intelligently handles both cases. When the user clicks the link, their device checks for the application and opens it if available. If the application is not installed, the device automatically redirects to the fallback webpage.

Having scanned the QR code and sent the encoded information from the QR code to the server, in FIG. 3B the user device application receives an authentication request from the server and submits an authentication credential, such as a PIN number. When the user scans the QR code with their user device application, the device's camera captures the QR code image. In some embodiments, a mobile application uses QR code scanning functionality, which utilizes computer vision algorithms and image processing techniques to extract the encoded information from the QR code image. The user device application securely communicates the entered PIN number to the server using encryption protocols and secure network connections. Though only a PIN number is illustrated in FIG. 3B, it is understood that other authentication credentials may be provided, including without limitation: a biometric such as a fingerprint scan, facial recognition (e.g. face ID), iris scanning, and voice scanning; a PIN or passcode; an OTP; or a security token.

In FIG. 3C, the user device application receives a list of transaction accounts associated with the information provided by the user at checkout and/or via the QR code information. The server processes the authentication request and retrieves the user's profile information. This includes the user's email address and other identifiers obtained from the QR code scan or the checkout process. The server then queries the relevant databases or systems to retrieve the list of transaction accounts associated with the user's profile. This retrieval process can involve without limitation database queries, API calls, or other mechanisms to fetch the necessary data. More specifically, the server can integrate with the banks' APIs by establishing a connection and communicating with them. The server sends requests to specific endpoints provided by the banks' API systems. To retrieve account information, the server can send a GET request to the appropriate API endpoint provided by the bank. The request may include parameters such as the user's authentication credentials, account number, or any other relevant details required by the API. The bank's API processes the request and generates a response. The response usually contains the requested account information, such as the account balance, transaction history, or other relevant data. The server can store the retrieved account information in a database or use it for further processing, analysis, or display within the application. The server can also aggregate data from multiple banks if needed, by making separate API requests to each bank's API and consolidating the responses.

Furthermore, the one or more accounts provided by the bank or account providers can be associated with one or more transaction cards such as credit cards, charge cards, debit cards, gift cards, rewards cards, or some other transaction card. In some embodiments, the bank and the server share information regarding the one or more transaction accounts associated with the user. In some embodiments, the server may query the bank through the API for each individual online transaction, i.e. the server may make separate requests for payment credentials for each transaction. In other embodiments, the server may have a relationship with the bank such that the payment credentials usually handled by the bank will be possessed by the server as well. That is, the server already has the payment credentials, so the server does not have to query the bank for every single transaction. This embodiment presumes that the server and the bank have already communicated with one another and have granted the server the permission to have and use the payment credentials associated with one or more transaction accounts associated with the user. In some embodiments, the server may query the bank through the API for each individual online transaction, i.e. the server may make separate requests for payment credentials for each transaction. In other embodiments, the server may have a relationship with the bank such that the payment credentials usually handled by the bank will be possessed by the server as well. That is, the server already has the payment credentials, so the server does not have to query the bank for every single transaction. This embodiment presumes that the server and the bank have already communicated with one another and have granted the server the permission to have and use the payment credentials associated with one or more transaction accounts associated with the user.

Once retrieved, the server transmits the list of transaction accounts to the user's user device application using secure communication channels and data serialization formats such as JSON or XML. The list can be shown on the user device's display, and the user can select one of many account. In FIG. 3C, the user can choose from one of three options labeled “Card #1,” “Card #2,” and “Card #3.” In other embodiments, the user can be provided with more or fewer selections. Each card can be associated with one or more transaction accounts associated with potentially one or more account providers.

Once the user selects the card, in FIG. 3D, the user has selected a transaction account from the list, and the server performs the transaction with the selected account. When the user selects a card from the list of transaction accounts on their user device application, the application securely communicates the user's selection back to the server. The server receives the user's choice and initiates the transaction process. This involves interacting with payment gateways, financial institutions, or other relevant systems to authorize and process the transaction. The server securely communicates the transaction details and payment information to the appropriate parties involved, such as the card issuer or the acquiring bank, to complete the transaction. Once the transaction is processed and confirmed, the server notifies the user device application and/or application about the transaction's completion, providing a confirmation message or status update that is visible on the display of the user device.

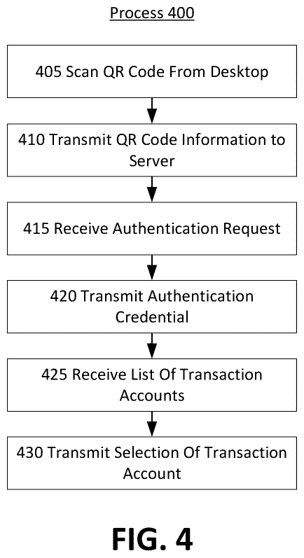

FIG. 4 illustrates a process from the perspective of a user device application associated with the user device discussed with further reference to FIG. 1.

In action 405, the user device application scans the QR code from the desktop. The processor activates the device's camera and utilizes computer vision algorithms and image processing techniques to capture and decode the QR code. These algorithms analyze the image data captured by the camera and extract the encoded information embedded in the QR code. The processor then converts this information into a usable format for further processing.

In action 410, the user device application upon scanning the QR code transmits the information contained in the QR code to the server. In some embodiments, the processor opens a user device application which is capable of scanning QR codes. In some embodiment, the user can open the application, then scan the QR code. The server receives the information from the QR code, i.e. the server decodes the captured QR code image, extracting the encoded information contained within it. The processor communicates with the operating system of the user device to launch the user device application. It passes the relevant information obtained from the QR code, such as the merchant's name, customer's unique ID, customer's email, and timestamp, to the server. This communication involves data serialization and transmission protocols, ensuring the secure transfer of the QR code information to the server.

In action 415, the user device application receives an authentication request from the server. The user device application establishes a secure communication channel with the server, utilizing encryption protocols and secure network connections. The server sends the authentication request to the user device application, indicating that the user needs to provide their authentication credential. The user device application receives and interprets this request, preparing for the user's response. In response, in action 420, the user device application transmits an authentication credential to the server. The user device application can securely communicate the user's chosen authentication credential, such as a PIN number, to the server. It can encrypt the credential to protect it during transmission and can employ secure protocols to ensure the confidentiality and integrity of the data.

Next, in action 425, the user device application receives a list of transaction accounts associated with the user. The user device application establishes a secure connection with the server and retrieves the requested list of transaction accounts. It communicates with the server or relevant databases, leveraging APIs or other mechanisms to fetch the account information. More specifically, the server can integrate with the banks' APIs by establishing a connection and communicating with them. The server sends requests to specific endpoints provided by the banks' API systems. To retrieve account information, the server can send a GET request to the appropriate API endpoint provided by the bank. The request may include parameters such as the user's authentication credentials, account number, or any other relevant details required by the API. The bank's API processes the request and generates a response. The response usually contains the requested account information, such as the account balance, transaction history, or other relevant data. The server can store the retrieved account information in a database or use it for further processing, analysis, or display within the application. The server can also aggregate data from multiple banks if needed, by making separate API requests to each bank's API and consolidating the responses.

Furthermore, the one or more accounts provided by the bank or account providers can be associated with one or more transaction cards such as credit cards, charge cards, debit cards, gift cards, rewards cards, or some other transaction card. In some embodiments, the bank and the server share information regarding the one or more transaction accounts associated with the user. In some embodiments, the server may query the bank through the API for each individual online transaction, i.e. the server may make separate requests for payment credentials for each transaction. In other embodiments, the server may have a relationship with the bank such that the payment credentials usually handled by the bank will be possessed by the server as well. That is, the server already has the payment credentials, so the server does not have to query the bank for every single transaction. This embodiment presumes that the server and the bank have already communicated with one another and have granted the server the permission to have and use the payment credentials associated with one or more transaction accounts associated with the user.

The received data is decrypted and processed by the processor, extracting the necessary details about the available transaction accounts. The list of transaction account can be displayed in a list format. The user device application can display the list on an electronic display or screen associated with a user device. The list can be interacted with by the user via the processor. Finally, in action 430, the user device application transmits the selection of the transaction account that the user wants to use to complete the transaction. The user device application securely communicates the user's selected transaction account to the server. It encrypts the data and establishes a secure connection with the server to transmit the selection. The user device application ensures the accuracy and integrity of the transmitted information, confirming that the chosen transaction account is associated with the user and valid for the intended transaction.

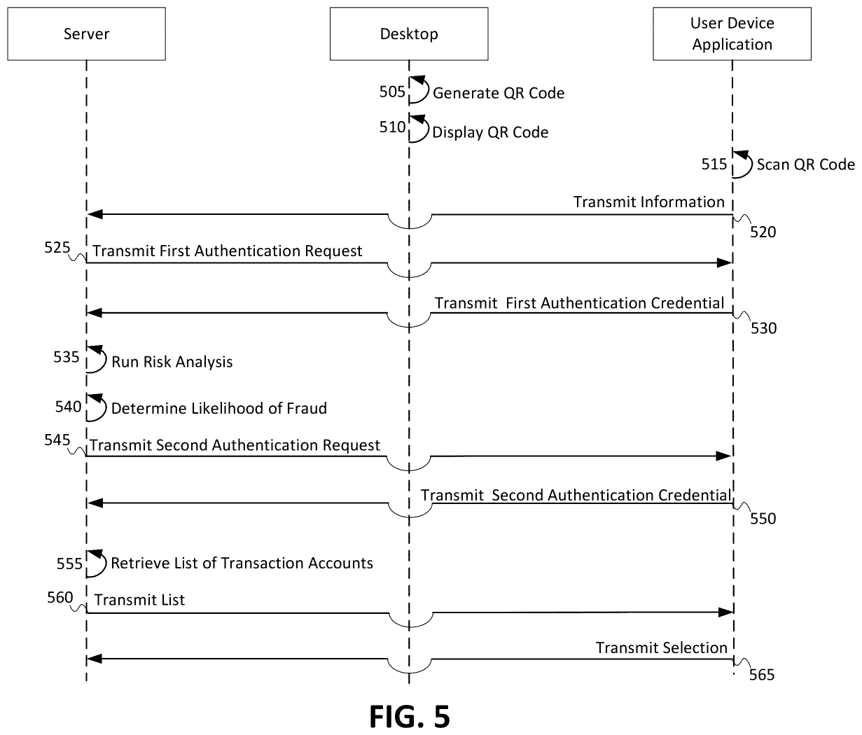

FIG. 5 is a sequence diagram illustrating a process according to an exemplary embodiment. The process can include a server, a desktop computer, and a user device application enabled with a memory and a processor. The desktop and server are also discussed with reference to FIG. 1. The server can be associated with a software application that is responsible for processing information via a user device application that is openable and usable on the user device. In FIG. 5, it is assumed that a user is performing a transaction on a desktop, but it is understood that in other embodiments the user may perform the transaction on any computer-enabled device with an electronic display discussed with further reference to FIG. 1. Having selected their item in an online transaction, the user arrives at a checkout page. Instead of inputting their checkout information such as payment and shipping information, the user can instead scan a QR code from the desktop screen to complete the transaction.

In action 505, a QR code can be generated by the desktop. The QR code is generated when a user device application accesses a merchant's website from a desktop device and initiates the authentication process. Its purpose is to provide a secure and efficient way to transfer essential information between the desktop and user devices. The QR code is generated by a secure token key (STK) embedded in the merchant website. When the user accesses the website, the STK detects the device type (e.g., a desktop computer) and generates a QR code specific to that device. The QR code can contain many kinds of information. In some embodiments, the QR code can contain the merchant's name, the unique identifier for the customer (e.g. customer ID), the user's email address, and a time stamp. For example, the name of the merchant associated with the checkout process is included in the QR code. The customer ID allows the customer to rejoin the same checkout session when they return to the website on the desktop, ensuring continuity and a seamless user experience. The customer's email address is sent over as an identifier to determine which banks are associated with that specific email address. It helps streamline the authentication process and allows for personalized card selection. In such an embodiment, the user could provide their email address before the QR code was generated. Finally, the QR code includes a time stamp to set an expiration period for the session. If the customer does not return within a certain timeframe, the session can expire, ensuring security and preventing unauthorized access. In other embodiments, other kind of customer information can be used such as a name, phone number, account number, address, or other personal identifying information.

The generated QR code is then displayed in action 510 on the merchant's website via the display of the desktop, typically in a prominent location where it is easily scannable by a user device application. Once the QR code is displayed, the user can scan the QR code in action 515 with the user device, which can comprise and/or be in data communication with a camera discussed with further reference to FIG. 1.

In action 520, the user device upon scanning the QR code opens the mobile application on their user device, which is capable of scanning QR codes. In some embodiments, the user can open the user device application in order to scan the QR code. Having opened the QR code, the user device application received the information from the QR code, i.e. the bank application decodes the captured QR code image, extracting the encoded information contained within it. This information may include the merchant's name, customer's unique ID, customer's email, and a timestamp. Once the QR code is successfully decoded, the server transfers the extracted information from the QR code into its own secure environment for further processing. With the relevant information from the QR code, the server initiates the authentication process.

In action 525, the server transmit an authentication request to the user device application. The user device can receive the authentication request through the application open on the user device application. In other embodiments, the authentication request can be received outside of the context of the application. For example, the user device application receives a notification or alert indicating that an authentication request has been received from the application. This notification may appear as a pop-up message, a push notification, or an in-app alert. Based on the provided information, the user decides whether to grant or deny authorization for the requested action. This decision is typically made through user interaction with the user device interface either with or without the context of the application.

In action 530, the user can provide an authentication credential that is sufficient to satisfy the authentication request. The user can provide any one of several different credentials: a biometric such as a fingerprint scan, facial recognition (e.g. face ID), iris scanning, and voice scanning; a PIN or passcode; a one time password (OTP); or a security token.

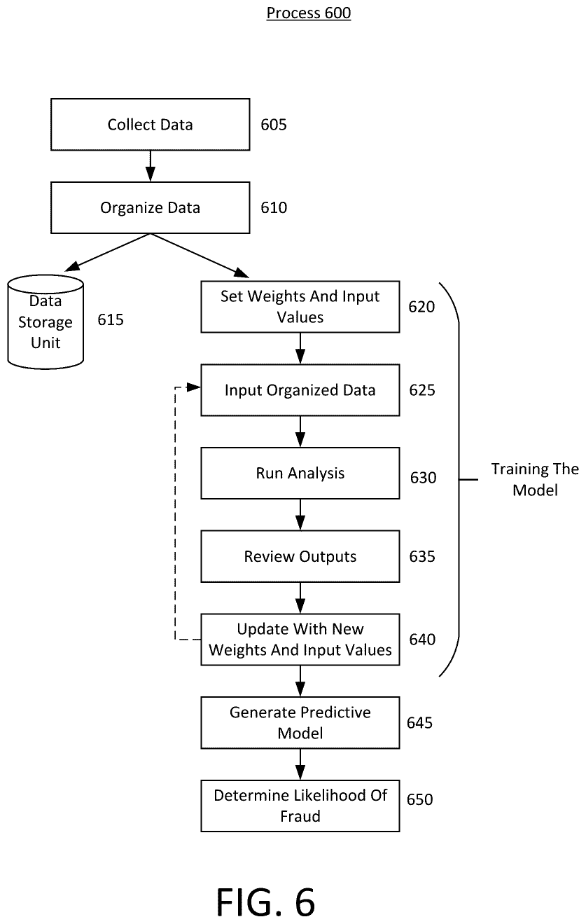

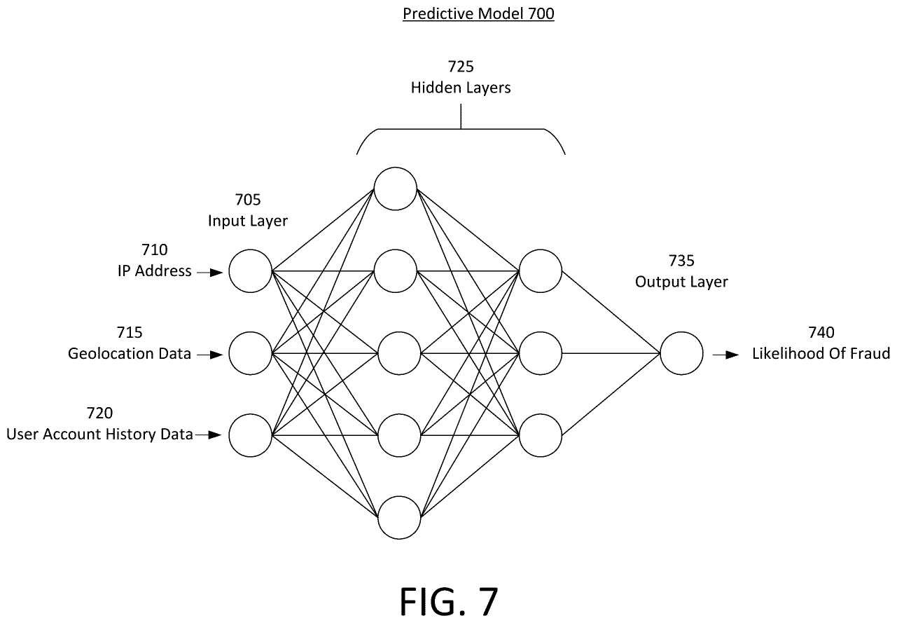

In action 535, the server can run a risk analysis discussed with further reference to FIGS. 6 and 7. During the checkout process, various risk factors are taken into consideration to evaluate the legitimacy of the transaction and determine the likelihood of fraud. These risks can be tested by risk engines associated with the server. Risk engines can utilize various data, such as IP addresses, to run risk assessments on transactions. Behavioral tracking on the merchant site can also provide valuable information, distinguishing between normal human browsing behavior and suspicious bot-like activity. Risk engines use advanced algorithms to analyze these data points and assign a risk score to the transaction. Based on the risk score or some similar metric, further actions can be taken to verify the transaction's legitimacy. As another example, recent changes in the shipping address may raise concerns about potentially fraudulent activity. If the shipping address differs from the original owner's address, it can indicate unauthorized shipping attempts. The risk analysis takes into account any changes in shipping information and flags suspicious changes for further investigation or verification. Furthermore, limits may be set on the number of attempts allowed to enter email or initiate the process before additional measures are taken. Velocity checks and monitoring for actions like copying and pasting of login credentials or username/password input methods help identify suspicious behavior. the system can identify potential risks and take appropriate actions to mitigate them, such as triggering additional authentication steps, displaying warning messages to users, or blocking suspicious transactions. Based on the risk analysis, the server can determine the likelihood of fraud in action 540.

Upon determining a likelihood of fraud, the server in action 545 the server transmits a second authentication request to the user device application. The user device application can receive the authentication request. In other embodiments, the authentication request can be received outside of the context of the application. For example, the user device receives a notification or alert indicating that an authentication request has been received from the application. This notification may appear as a pop-up message, a push notification, or an in-app alert. Based on the provided information, the user decides whether to grant or deny authorization for the requested action. This decision is typically made through user interaction with the user interface either with or without the context of the application. In action 550, the user can provide a second authentication credential that is different from the first authentication credential and that is sufficient to satisfy the authentication request. The user can provide any one of several different credentials: a biometric such as a fingerprint scan, facial recognition (e.g. face ID), iris scanning, and voice scanning; a PIN or passcode; an OTP; or a security token.

Having received the authentication credential, the server in action 555 can retrieve a list of one or more transaction accounts associated with the information provided from the QR code, e.g. an email address, phone number, name, account number, customer ID, or some other identifying information. The list can be retrieved by matching the identifying information with one or more transaction accounts from one or more account providers. For example, the server can retrieve a list of three spending accounts from three different banks. These transaction accounts can include various payment methods, such as credit cards, debit cards, digital wallets, or other financial accounts. It is presumed that the server has access to a consortium style approach regarding the access to the one or more transaction accounts. A consortium-style approach, in the context of the described scenario, refers to a collaborative framework between the server and one or more account providers, such as banks, to streamline the authentication and payment process. The consortium-style approach allows for the inclusion of multiple banks within the authentication and payment process. This means that users can authenticate and make payments using their accounts from different banks. In action 560, the server can transmit the list of the transaction accounts to the user device application. The user device receives the transmitted data and displays the list of transaction accounts to the user. In some embodiments, the accounts can be presented in a user-friendly format, showing relevant details such as the account names, associated logos, and potentially other information like available balances or rewards points. In action 565, the user reviews the available transaction accounts and selects the desired account for the transaction, thereby transmitting their selection to the server. They can choose a specific credit card, debit card, or any other supported payment method from the list. Once the user makes their selection, the user device application sends a confirmation or authorization request back to the server. This request includes the chosen transaction account or payment method, indicating the user's intent to use that account for the transaction. The server receives the selection from the user device application and proceeds with processing the transaction using the selected transaction account. This may involve interacting with payment gateways, financial institutions, or other relevant entities to facilitate the transaction.

FIG. 6 is a flowchart illustrating the generation of a predictive model and the determination of a likelihood of fraud. The predictive model can be made, trained, and used by the server discussed with further reference to FIGS. 1, 2, and 5.

The process 600 describes the training process for an exemplary predictive model or neural network suitable for the predicting and generating of one or more risk analyses including at least a grade of whether an online transaction has a likelihood of fraud, such as being high risk, medium risk, or low risk. The process can begin with action 605 when data is collected. The raw data can be associated with the user device, the user device application, and the online transaction itself. The information can further include IP address; browser configuration; network details; stock keeping unit (SKU) data associated with the online transaction; search activities; product page views; typing patterns; typing speeds; geolocation data; time and date data; user account history data; device information; and referral source. The collection of raw data can be performed by the server, which itself can be associated with a merchant website, merchant application, and user device application. The raw data can be directly observed and retrieved by the server, and other raw data can be transmitted over a wired or wireless network from the user device application and desktop to the server. In some embodiments, the data can be retrieved from the QR code once scanned and transmitted by the user device application. The data may have been previously gathered and stored in a database or data storage unit in which case the user device application or the server can retrieve the data from the data storage unit. The data can be received continuously or in batches. The raw data can be updated at any time. At action 610, the server can organize the raw data into discernable categories including but not limited to location data, transaction data, and user device data. The categories can be predetermined by the user or created by the predictive model. At action 615, the organized data can be transmitted to the data storage unit. The data storage unit can be associated with the server. The raw or organized data can be transmitted over a wired network, wireless network, or one or more express buses. Upon organizing the data into one or categories, the server can proceed with training the predictive model in actions 620 through 640. The training portion can have any number of iterations. The predictive model can comprise one or more neural networks described with further reference to FIG. 7.

The training portion can begin with action 620 when the weights and input values are set by the user or by the model itself. Furthermore, the weights can be the predetermined connections between the inputs and the hidden layers described with further reference to FIG. 7. The input values are the values that are fed into the neural network. The input values may be discerned by the different categories created in action 610, although other distinct input values may be discerned. The inputs can include without limitation historical information related to the user's past transactions, other third party data about signs of fraud, and the user device. In action 625, the data in inputted in the neural network, and in action 630 the neural network analyzes the data according to the weights and other parameters set by the user. As a nonlimiting, example, the central processor may create the stipulation that any transaction with more than 10 items being purchased must be assessed as at least medium risk and up to high risk. In action 635, the outputs are reviewed. The outputs can include one or more likelihoods of fraud varying from high risk, medium risk, to low risk. In other embodiments, the central processor may only grade for low risk or high risk. In still other embodiments, the central processor generate a numerical score or letter grade each with discrete value such as a percentage of likelihood of fraud. In still other embodiments, the server can generate a slidable scale of riskiness associated with the online transaction.

In action 640, the predictive model may be updated with new data and parameters. The new data can be collected by the server in a similar fashion to actions 605 and 610. Though it is not necessary in this exemplary embodiment to retrain the predictive model, the predictive model can be re-trained any number times such that actions 625 through 640 are repeated until a satisfactory output is achieved or some other parameter has been met. As a nonlimiting example, the server may update the inputs with new changeable areas. As another nonlimiting example, the server can adjust the weighted relationship between the input layer and the one or more hidden layers of a neural network discussed with further reference to FIG. 7. If a satisfactory output has been recorded, then in action 645 one or more predictive models can be generated. It is understood that the predictive model, once generated, can undergo further training like actions 620 to 645. Having generated the predictive model, in action 650 the model can generate one or more likelihoods of fraud given the unique input values collected from a particular online transaction and its associated user device.

FIG. 7 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. A neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 700. The neural network may be integrated into the server. The neural network can include an input layer 705, one or more hidden layers 725, and an output layer 735. Although only a certain number of nodes are depicted in FIG. 7, it is understood that the neural network according to the disclosed embodiments may include less or more nodes in each layer. Additionally, the hidden layers can include more or less layers than what is depicted in FIG. 7. It is also understood that the connections between each layer may be assigned a predetermined weight according to the server's change or according to some weight value generated by the neural network itself. The input layer may include sets of data gathered from outside sources. The neural network can include an IP address 710, geolocation data 715, and user account history data 720, each of which can be associated with the user and user device associated with the online transaction. Other inputs not depicted in FIG. 7 can include: browser configuration; network details; stock keeping unit (SKU) data associated with the online transaction; search activities; product page views; typing patterns; typing speeds; time and date data; device information; and referral source. Upon analyzing the inputs via the one or more hidden layers, the neural network can create one or more fraud likelihoods 740. It is understood that one or more neural networks or some combination of neural networks can be trained according to individual users. It is understood that any of the neural networks described herein may be trained or iterated any number of times. In some embodiments, the neural network can be re-trained and/or updated after every recordation of new online consumer transaction. In still other embodiments, the neural network can be trained until a sufficient level of accuracy has been reached.

In some embodiments, the application can analyze document information using a predictive model including without limitation a recursive neural network (RNN), convolutional neural network (CNN), artificial neural network (ANN), or some other neural network. The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as CNNs or RNNs, to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

In some aspects, the techniques described herein relate to a method for user authentication and card provisioning, including: scanning, by user device application including instructions for execution on a user device including a processor and a memory, a quick response (QR) code from an electronic display; receiving, by the user device application, an authentication request from a server; transmitting, by the user device application, an authentication credential to the server; receiving, by the user device application from the server, a list of one or more transaction accounts associated with one or more account providers associated with the user; and transmitting, by the user device application to the server, a selection of one transaction account, wherein the selection triggers the server to transmit one transaction account information to a merchant, and wherein the transaction account information is sufficient to complete a transaction.

In some aspects, the techniques described herein relate to a method, wherein the authentication credential includes at least one selected from the group of a biometric, personal identification number (PIN), and one time password (OTP).

In some aspects, the techniques described herein relate to a method, wherein the QR code includes a merchant name, a unique identifier (ID) associated with the user, an email associated with the user, and a timestamp.

In some aspects, the techniques described herein relate to a method, wherein the method further includes storing the user's selection of the one transaction account in a data storage unit.

In some aspects, the techniques described herein relate to a method, wherein the list of one or more transaction accounts is displayed on the user device.

In some aspects, the techniques described herein relate to a method, wherein the server, upon receiving the selection, transmits a payment token to the merchant to complete a transaction.

In some aspects, the techniques described herein relate to a method, wherein the server transmits a virtual card number (VCN) to the merchant.

In some aspects, the techniques described herein relate to a method, wherein the transaction account information includes at least an account number, expiration date, and cardholder name associated with the selected transaction account.

In some aspects, the techniques described herein relate to a method, wherein the electronic display is associated with a desktop computer.

In some aspects, the techniques described herein relate to a system for user authentication and card provisioning, including: user device application including instructions for execution on a user device including a processor and a memory, the user device application configured to: scan a quick response (QR) code from an electronic display; receive an authentication request from a server; transmit an authentication credential to the server; receive a list of one or more account providers associated with the user; and transmit, by the processor to the server, a selection of one transaction account, wherein the selection triggers the server to transmit transaction account information to a merchant, and wherein the transaction account information is sufficient to complete a transaction.

In some aspects, the techniques described herein relate to a system, the QR code includes a universal resource locator (URL) configured to launch a corresponding bank application on a user device associated with the user.

In some aspects, the techniques described herein relate to a system, wherein the server, performs a risk analysis based on a transaction history associated with the user.

In some aspects, the techniques described herein relate to a system, wherein the server, upon performing the risk analysis, determines whether the transaction is likely to be fraudulent.

In some aspects, the techniques described herein relate to a system, wherein the server, upon determining that the transaction is likely to be fraudulent, transmits a second authentication request to the processor.

In some aspects, the techniques described herein relate to a system, wherein the server transmits a virtual card number (VCN) to the merchant.

In some aspects, the techniques described herein relate to a system, wherein the VCN is configured to expire after a predetermined time period.

In some aspects, the techniques described herein relate to a system, wherein the VCN further includes a spending limit.

In some aspects, the techniques described herein relate to a system, wherein the processor opens a website associated with the server.

In some aspects, the techniques described herein relate to a system, wherein the server, upon receiving the selection, is further triggered to transmit account provisioning information to the merchant.

In some aspects, the techniques described herein relate to a computer readable non-transitory medium including computer executable instructions that, when executed by a computer hardware arrangement including a processor, causes the computer hardware arrangement to perform procedures including: scanning a quick response (QR) code from electronic display; receiving an authentication request from a server; transmitting an authentication credential to the server; receiving, from the server, a list of one or more account providers associated with the user; and transmitting, to the server, a selection of one account provider, wherein the selection triggers the server to transmit one or more transaction account information to a merchant, and wherein the transaction account information is sufficient to complete a transaction.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

Throughout the disclosure, the term “bank” is used, and it is understood that the present disclosure is not limited to a particular bank or type of bank. Rather, the present disclosure includes any type of bank or other business involved in activities where products or services are sold or otherwise provided.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “providing” is defined herein in its broadest sense, e.g., bringing/coming into physical existence, making available, and/or supplying to someone or something, in whole or in multiple parts at once or over a period of time.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

What is claimed is:

1. A method for user authentication and card provisioning, comprising:
scanning, by user device application comprising instructions for execution on a user device comprising a processor and a memory, a quick response (QR) code from an electronic display;
receiving, by the user device application, an authentication request from a server;
transmitting, by the user device application, an authentication credential to the server;
receiving, by the user device application from the server, a list of one or more transaction accounts associated with one or more account providers associated with the user; and
transmitting, by the user device application to the server, a selection of one transaction account,
wherein the selection triggers the server to transmit one transaction account information to a merchant, and
wherein the transaction account information is sufficient to complete a transaction.

2. The method of claim 1, wherein the authentication credential comprises at least one selected from the group of a biometric, personal identification number (PIN), and one time password (OTP).

3. The method of claim 1, wherein the QR code comprises a merchant name, a unique identifier (ID) associated with the user, an email associated with the user, and a timestamp.

4. The method of claim 1, wherein the method further comprises storing the user's selection of the one transaction account in a data storage unit.

5. The method of claim 1, wherein the list of one or more transaction accounts is displayed on the user device.

6. The method of claim 1, wherein the server, upon receiving the selection, transmits a payment token to the merchant to complete the transaction.

7. The method of claim 1, wherein the server transmits a virtual card number (VCN) to the merchant.

8. The method of claim 1, wherein the transaction account information comprises at least an account number, expiration date, and cardholder name associated with the selected transaction account.

9. The method of claim 1, wherein the electronic display is associated with a desktop computer.

10. A system for user authentication and card provisioning, comprising:
user device application comprising instructions for execution on a user device comprising a processor and a memory, the user device application configured to:
scan a quick response (QR) code from an electronic display;
receive an authentication request from a server;
transmit an authentication credential to the server;
receive a list of one or more account providers associated with the user; and
transmit, by the processor to the server, a selection of one transaction account,
wherein the selection triggers the server to transmit transaction account information to a merchant, and
wherein the transaction account information is sufficient to complete a transaction.

11. The system of claim 10, the QR code comprises a universal resource locator (URL) configured to launch the user device application.

12. The system of claim 10, wherein the server, performs a risk analysis based on a transaction history associated with the user.

13. The system of claim 12, wherein the server, upon performing the risk analysis, determines whether the transaction is likely to be fraudulent.

14. The system of claim 13, wherein the server, upon determining that the transaction is likely to be fraudulent, transmits a second authentication request to the processor.

15. The system of claim 10, wherein the server transmits a virtual card number (VCN) to the merchant.

16. The system of claim 15, wherein the VCN is configured to expire after a predetermined time period.

17. The system of claim 16, wherein the VCN further comprises a spending limit.

18. The system of claim 10, wherein the processor opens a website associated with the server.

19. The system of claim 10, wherein the server, upon receiving the selection, is further triggered to transmit account provisioning information to the merchant.

20. A computer readable non-transitory medium comprising computer executable instructions that, when executed by a computer hardware arrangement comprising a processor, causes the computer hardware arrangement to perform procedures comprising:
scanning a quick response (QR) code from electronic display;
receiving an authentication request from a server;
transmitting an authentication credential to the server;
receiving, from the server, a list of one or more account providers associated with a user; and
transmitting, to the server, a selection of one account provider,
wherein the selection triggers the server to transmit one or more transaction account information to a merchant, and
wherein the transaction account information is sufficient to complete a transaction.
